(19) United States
(12) Patent Application Publication
(10) Pub. No.: US 2024/0302883 A1
(43) Pub. Date: Sep. 12, 2024

(54) ROLLABLE SCREEN DEVICE POWER MANAGEMENT

(71) Applicant: Motorola Mobility LLC, Chicago, IL (US)

(72) Inventors: Ashok Oliver Prabhu, Bangalore (IN); Sindhu Chamathakundil, Bangalore (IN); Xiaofeng Zhu, Nanjing (CN)

(73) Assignee: Motorola Mobility LLC, Chicago, IL (US)

(21) Appl. No.: 18/185,974

(22) Filed: Mar. 17, 2023

(30) Foreign Application Priority Data
Mar. 10, 2023 (CN) 202310229081.1

(51) Int. Cl. G06F 1/3212; G06F 1/16

(52) U.S. Cl. CPC G06F 1/3212; G06F 1/1624; G06F 1/1652; G06F 1/1677

(57) ABSTRACT

In aspects of rollable screen device power management, a mobile device includes a rollable display screen configurable in one of multiple display states corresponding to respective device form factors, such as a compact form factor, an expanded form factor, and a partial form factor. A slidable display mount is operable to one of extend or retract the rollable display screen into one of the multiple display states corresponding to a device form factor. A configuration manager is configured to limit powered operation of the slidable display mount for configuration of the rollable display screen based at least in part on a determination of low battery power.

### RELATED APPLICATION

This application claims priority benefit of China Patent Application for Invention Serial No. 202310229081.1 filed Mar. 10, 2023 entitled “Rollable Screen Device Power Management”, the disclosure of which is incorporated by reference herein in its entirety.

### BACKGROUND

Devices such as smart devices, mobile devices (e.g., cellular phones, tablet devices, smartphones), consumer electronics, and the like can be implemented for use in a wide range of environments and for a variety of different applications. Generally, mobile devices come in varying sizes and form factors, such as rectangular with an overall rigid shape, foldable devices with a housing that is hinged allowing a device to fold, and slidable devices with housing sections that slide apart and back together. Consumers typically want smaller devices that are convenient to carry, yet also prefer devices that have some expandability for larger display viewing, such as with the foldable and slidable devices.

### BRIEF DESCRIPTION OF THE DRAWINGS

Implementations of the techniques for rollable screen device power management are described with reference to the following Figures. The same numbers may be used throughout to reference like features and components shown in the Figures:

FIG. 1 illustrates an example system for rollable screen device power management in accordance with one or more implementations as described herein.

FIG. 2 further illustrates example views of a mobile device, which supports rollable screen device power management in accordance with one or more implementations as described herein.

FIG. 3 further illustrates example views of the mobile device, which supports rollable screen device power management in accordance with one or more implementations as described herein.

FIG. 4 further illustrates example views of the mobile device, which supports rollable screen device power management in accordance with one or more implementations as described herein.

FIG. 5 illustrates example views of a rollable display screen and mounting assembly, which supports rollable screen device power management in accordance with one or more implementations as described herein.

FIG. 6 illustrates an example of a user interface, which supports rollable screen device power management in accordance with one or more implementations as described herein.

FIGS. 7-12 illustrate example methods for rollable screen device power management in accordance with one or more implementations of the techniques described herein.

FIG. 13 illustrates various components of an example device that can be used to implement the techniques for rollable screen device power management as described herein.

### DETAILED DESCRIPTION

Implementations of techniques for rollable screen device power management are implemented as described herein. A rollable screen device, such as a mobile device (e.g., any type of mobile phone, wireless device, camera device, laptop computer, and/or electronic device) can include a rollable display screen that can be configured in any one of various display states, which correspond to respective mobile device form factors. For example, device form factors can include a compact form factor, an expanded form factor, a partial form factor (also referred to as a “peek” form factor), as well as other device form factors, such as any increment of display states between the compact form factor and the expanded form factor. The mobile device includes a slidable display mount that is a powered sliding or translation mechanism operable to transition the rollable display screen between the various display states. In one or more implementations, the rollable display screen may be extended or retracted automatically, such as based on whether content is being displayed on the display screen for viewing, a size of the displayed content, and/or based on the type of displayed content.

In aspects of the described techniques, a configuration manager of the mobile device manages battery power consumption to configure, and reconfigure, the rollable display screen in the different display states, which correspond to the various device form factors. Notably, powering the slidable display mount to translate the rollable display screen between the display states for the various device form factors consumes battery power of the device battery. Additionally, utilizing a larger display area of the rollable display screen to display content consumes more battery power than a smaller display area of the display screen due to the larger screen area for rendering. In implementations, the configuration manager determines or detects low battery power of the device battery, and limits powered operation of the slidable display mount for configuration of the rollable display screen. This allows the mobile device to operate longer in the low battery power condition.

Given that the rollable display screen consumes a significant percentage of the battery power while in use, the configuration manager is implemented to limit the screen size and/or using battery power to reconfigure a display state of the display screen. In implementations, the rollable display screen of the mobile device can be transitioned or configured in one of the display states at run-time based on the use case (e.g., based on the content being displayed on the display screen). As described herein, an extended display state of the rollable display screen corresponds to the expanded form factor of the mobile device, a retracted display state of the rollable display screen corresponds to the compact form factor of the mobile device, and a sensor display state of the rollable display screen corresponds to the partial form factor of the mobile device.

Although the specific display states are intended to provide an optimum user experience in a respective device form factor, each of the display states are implemented to provide a reasonable user experience for all of the use cases. For example, streaming video content is best viewed in the extended display state of the rollable display screen in the expanded form factor of the mobile device. However, the streaming video content can also be viewed in the retracted display state of the display screen (e.g., corresponding to the compact form factor of the device), and can be viewed in the sensor display state of the display screen (e.g., corresponding to the partial form factor of the device). Accordingly, when the mobile device is running on a low battery, the configuration manager can initiate to configure the rollable display screen in a display state that is adequate for all use cases with respect to battery power consumption.

In an example, the retracted display state of the rollable display screen corresponding to the compact form factor of the mobile device can be utilized for displaying and viewing content with minimum battery power consumption. The configuration manager can limit the screen size to the retracted display state and limits use of battery power to move the rollable display screen. Similarly, the sensor display state of the rollable display screen corresponding to the partial form factor of the mobile device (e.g., also referred to as the “peek” form factor) can be utilized for displaying and viewing content on the display screen. The front-facing viewable size of the rollable display screen in the sensor display state conserves battery power while also providing that functionality of the device sensors, such as a front-facing camera, environment sensors, and a phone earpiece speaker, is available for use without having to power the slidable display mount and reconfigure the rollable display screen.

In various implementations, the configuration manager determines or detects the low battery power of the device battery, and maintains the rollable display screen in the current display state and form factor of the device, such as by limiting the powered operation of the slidable display mount that translates the display screen into the different display states. As an alternative to determining the low battery power and maintaining the current display state, the configuration manager can determine the low battery power and first initiate to configure the rollable display screen in a predefined low power display state, and then limit the powered operation of the slidable display mount after the rollable display screen is configured in the predefined low power display state. Accordingly, low battery power of the device battery is determined or detected, some battery power is used to reconfigure the rollable display screen in a display state (e.g., in a predefined low power display state), and then remaining battery power is conserved by limiting display screen translation.

In an implementation, the predefined low power display state may be a user preferred display state of the rollable display screen, such as if the user of the device prefers to configure the rollable display screen in the sensor display state (corresponding to the partial form factor of the device) rather than in the retracted display state (corresponding to the compact form factor of the device) when operating in the low battery power mode. In similar implementations, the configuration manager can determine that a current display state of the rollable display screen utilizes less battery power than reconfiguring the display screen in a different display state, and maintain the rollable display screen in the current display state. Alternatively, the configuration manager can determine that a current display state of the rollable display screen utilizes more battery power than reconfiguring the rollable display screen in a different display state, and initiate to reconfigure the display screen corresponding to either the compact form factor or the partial form factor of the mobile device.

In another implementation, the configuration manager receives a configuration input of a display state of the rollable display screen, initiates to configure the rollable display screen according to the configuration input, and then maintains the rollable display screen in the display state corresponding to the configuration input. In an example, the configuration input is a user-selected display state of the rollable display screen corresponding to any of the device form factors, such as the compact form factor, the expanded form factor, or the partial form factor of the device. In this example, the user of the device can select the display state of the rollable display screen via a user interface selectable mode control displayed on a user interface, or via another type of selectable device control, such as by sensor input or switch input. A user interface can be utilized to displays hours of remaining device operation based on the battery power of the device battery, and the selectable battery modes that correspond to the device form factors.

In implementations, the battery modes include a conserve mode, a balanced mode, and a performance mode. The device form factors may include the compact form factor or the partial form factor corresponding to the conserve mode of battery utilization, and may include the expanded form factor or the partial form factor corresponding to the performance mode of battery utilization. In the performance battery mode, the configuration manager continues to automatically configure the rollable display screen according to the predefined auto-expand and retract use cases, such as according to the content being displayed on the display screen. In the balanced battery mode, the configuration manager is implemented to automatically expand and retract the rollable display screen in a balanced manner, such as when taking a phone call or for messaging applications, but the fully extended display state may be limited, or the rollable display screen may be partially extended. This may also be controlled or predefined by user preferences and/or based on usage patterns, such as how the user typically uses the device and in which battery modes, display states, and/or device form factors. In the conserve battery mode, the configuration manager continues to limit powered operation to reconfigure the rollable display screen, and maintains the display screen in the current display state.

While features and concepts of the described techniques for rollable screen device power management can be implemented in any number of different devices, systems, environments, and/or configurations, implementations of the techniques for rollable screen device power management are described in the context of the following example devices, systems, and methods.

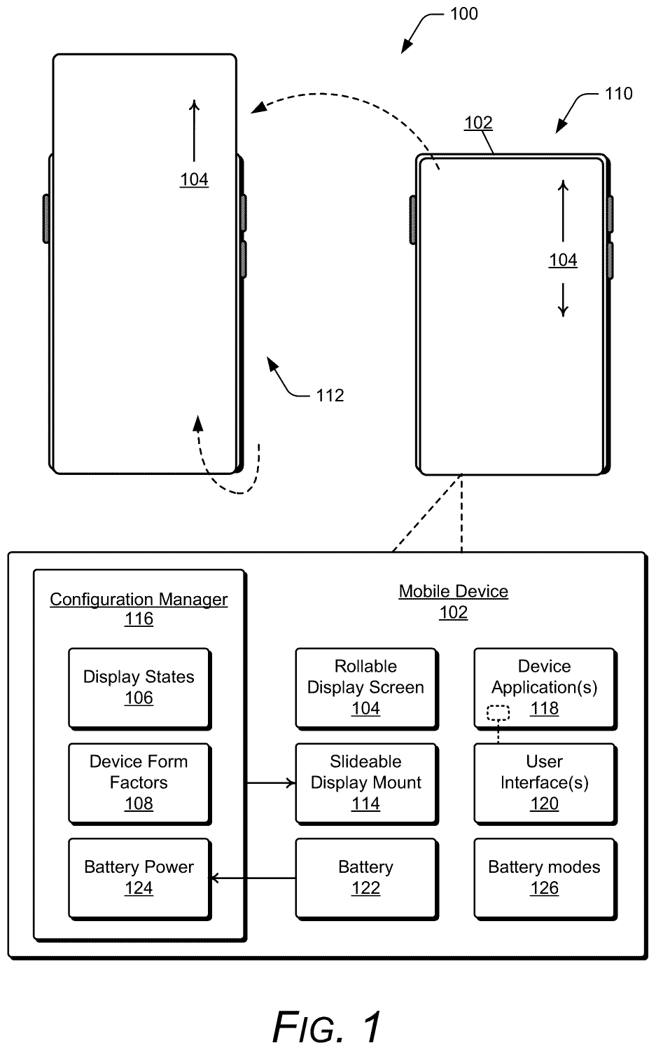

FIG. 1 illustrates an example system 100 for rollable screen device power management, as described herein. The example system 100 includes a mobile device 102, such as a smartphone, mobile phone, wireless device, and/or any other type of wireless device. The mobile device 102 can be implemented with various components, such as a processor system and memory, as well as any number and combination of different components as further described with reference to the example device shown in FIG. 13. In implementations, the mobile device 102 includes various radios for wireless communication with other devices. For example, the mobile device 102 may include a Bluetooth (BT) and/or Bluetooth Low Energy (BLE) transceiver and/or a near field communication (NFC) transceiver. The mobile device 102 may also include a Wi-Fi radio, a GPS radio, and/or any type of device communication interfaces.

The mobile device 102 has a rollable display screen 104 that can be configured in any one of various display states 106 corresponding to respective mobile device form factors 108. For example, the device form factors 108 can include a compact form factor, an expanded form factor, a partial form factor (also referred to as a “peek” form factor), as well as other device form factors, such as any increment of display states between the compact form factor and the expanded form factor. In this example system 100, the mobile device 102 is shown in the compact form factor at 110, with the rollable display screen 104 configured in a retracted display state that corresponds to the compact form factor of the device. Further, the mobile device 102 is shown in the expanded form factor at 112, with the rollable display screen 104 configured in an extended display state. The rollable display screen 104 is a flexible display that translates between the retracted display state to the extended display state, and back. In one or more implementations, the rollable display screen 104 is an organic light emitting diode (OLED) display fabricated on a flexible plastic substrate, which allows the flexible display to deform around the device housing.

The mobile device 102 includes a slidable display mount 114 that is a powered sliding or translation mechanism (e.g., an actuator, motor, gear assembly, drive screws, etc.) operable to transition the rollable display screen 104 around the surfaces of the device housing, such as between the extended display state where the rollable display screen 104 extends distally from the device housing, and the retracted display state where the rollable display screen 104 corresponds to the compact form factor of the device with the flexible display wrapping around the surfaces of the device housing. In one or more implementations, the rollable display screen 104 may be extended or retracted automatically, such as based on whether content is being displayed on the display screen for viewing, a size of the displayed content, and/or based on the type of displayed content. For example, a user may prefer the mobile device 102 in the compact form factor as shown at 110 for ease of carrying, and then when initiating to playback content for viewing, the rollable display screen 104 automatically extends from the retracted display state to the extended display state for full-screen viewing, as shown at 112 in the expanded form factor of the device.

The mobile device 102 includes various functionality that enables the mobile device to implement different aspects of rollable screen device power management, as described herein. In this example system 100, the mobile device 102 includes a configuration manager 116 that represents functionality (e.g., logic, software, and/or hardware) enabling the automatic function control of the slidable display mount 114 for translating and positioning the rollable display screen 104. The configuration manager 116 can be implemented as computer instructions stored on computer-readable storage media (e.g., memory of the device), or in any other suitable memory device or electronic data storage, and can be executed by a processor system of the device. Alternatively or in addition, the configuration manager 116 can be implemented at least partially in firmware and/or at least partially in computer hardware. For example, at least part of the configuration manager 116 may be executable by a computer processor, and/or at least part of the configuration manager may be implemented in logic circuitry. In one or more implementations, the configuration manager 116 may include independent processing, memory, and/or logic components functioning as a computing and/or electronic device integrated with the mobile device 102.

The mobile device 102 can include and implement various device applications 118, such as any type of messaging application, email application, video communication application, cellular communication application, music application, gaming application, media application, social platform applications, and/or any other of the many possible types of device applications. Many of the device applications 118 have an associated application user interface 120 that is generated and displayed for user interaction and/or viewing, such as on the rollable display screen 104 of the mobile device 102. Generally, an application user interface, or any other type of video, image, graphic, and the like is digital image content that is displayable on the rollable display screen 104 of the mobile device. In this example system 100, the configuration manager 116 can be implemented as a software application or module, such as executable software instructions that are executable with a processor system of the mobile device 102 to implement the techniques and features described herein. As a device application, the configuration manager 116 may have an associated application user interface 120 that is generated and displayable for user interaction and viewing, such as on the rollable display screen 104 of the mobile device.

The rollable display screen 104 can be utilized to display any of various types of content on the mobile device 102. In one or more implementations, the mobile device 102 generates and/or outputs content from a device application 118 and/or operating system of the device, and the content is displayed on the rollable display screen 104. For example, a media application may receive streaming content from a remote server via a communication network for display on the rollable display screen.

Any of the devices, applications, modules, servers, and/or services described herein can communicate via a communication network, such as for data communication between the mobile device 102 and other communication and/or computing devices. The communication network can be implemented to include a wired and/or a wireless network, may be implemented using any type of network topology and/or communication protocol, and can be represented or otherwise implemented as a combination of two or more networks, to include IP-based networks and/or the Internet. The communication network may also include mobile operator networks that are managed by a mobile network operator and/or other network operators, such as a communication service provider, mobile phone provider, and/or Internet service provider.

In this example system 100, the mobile device 102 also includes a battery 122 or any other type of similar power source, such as described with reference to the example device shown in FIG. 13, to power features of the mobile device, including the slidable display mount 114 that is the powered sliding or translation mechanism operable to transition the rollable display screen 104 around the surfaces of the device housing. In one or more implementations, the configuration manager 116 can receive an indication of battery power 124, such as an indication of battery usage of the battery 122, remaining battery power of the battery, an indication of low battery power, and/or whether the device is plugged into an external power source and the battery is charging.

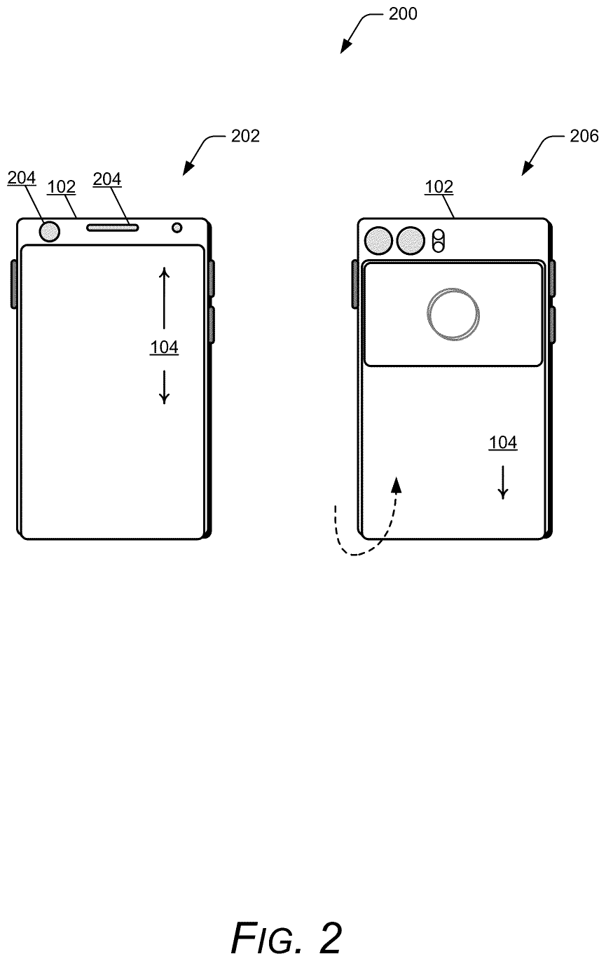

In one or more implementations, the mobile device 102 may also be configured in other device form factors 108, such as a partial form factor, which is further shown and described with reference to FIG. 2. As noted above, the partial form factor may also be referred to as a “peek” form factor, and in this configuration, the rollable display screen 104 translates down (e.g., in an opposite direction of the extended display state). This display state provides for an unobstructed sensory view of various device sensors and/or components that are otherwise hidden behind the rollable display screen 104 in both the compact form factor (retracted display state) and expanded form factor (extended display state). For example, sensors such as a front-facing camera, environment sensors (e.g., for motion, sound, lighting, etc.), a proximity sensor, and/or a phone earpiece speaker can all be integrated in the mobile device 102 under the rollable display screen 104, and the slidable display mount 114 translates the display screen over or above the sensors. These under-the-display screen sensors are then exposed or visible for use in the sensor display state of the rollable display screen 104, which corresponds to the partial form factor of the mobile device 102.

In implementations, the configuration manager 116 can initiate to configure the mobile device 102 in the partial form factor corresponding to the sensor display state of the rollable display screen 104 when an incoming voice call will require user access to the phone earpiece speaker, or when the front-facing camera is needed for image capture. Although generally described throughout this disclosure as the configuration manager 116 initiating and/or automatically controlling the configuration and/or reconfiguration of the mobile device form factors 108, a user of the device may initiate to configure the device in any form factor and/or display state of the rollable display screen, and override configuration settings of the configuration manager.

In one or more implementations, a portion of the rollable display screen 104 rotates around the housing of the mobile device 102, such as in the compact form factor of the device, forming a rear-facing portion of the display screen (e.g., relative to the front-facing portion of the display screen shown in the compact form factor at 110 and in the expanded form factor at 112 in the example system 100). In implementations, both the front-facing portion and the rear-facing portion of the rollable display screen 104 can be used to display content, such as related content or content associated with two different applications. In the expanded form factor of the mobile device 102, the rear-facing portion of the rollable display screen 104 rotates around the device housing and becomes part of the front-facing portion of the display screen. Notably, the viewable display area of the rollable display screen 104 varies as the display screen is translated from the sensor display state to the retracted display state to the extended display state, and back.

In one or more implementations of the techniques described herein for rollable screen device power management, the configuration manager 116 manages battery power consumption to configure, and reconfigure, the rollable display screen 104 in the different display states 106 corresponding to the various device form factors 108. Notably, powering the slidable display mount 114 to translate the rollable display screen 104 between the display states 106 for the various device form factors 108 consumes battery power of the device battery 122. Additionally, utilizing a larger display area of the rollable display screen 104 (e.g., the expanded form factor of the device in the extended display state) to display content consumes more battery power than a smaller display area of the display screen due to the larger screen area for rendering. When the configuration manager 116 determines or detects low battery power 124 of the device battery 122, the configuration manager can limit powered operation of the slidable display mount 114 for configuration of the rollable display screen 104 based on the determination or detection of the low battery power. This allows the mobile device 102 to operate longer in the low battery power condition.

Given that the rollable display screen 104 consumes a significant percentage of the battery power while in use, the configuration manager 116 is implemented to limit the screen size and/or using battery power to reconfigure a display state of the display screen. In one or more implementations, the rollable display screen 104 of the mobile device 102 can be transitioned or configured in one of the display states 106 at run-time based on the use case (e.g., based on the content being displayed on the rollable display screen). As described herein, the extended display state of the rollable display screen 104 corresponds to the expanded form factor of the mobile device 102, the retracted display state of the rollable display screen corresponds to the compact form factor of the mobile device, and the sensor display state of the rollable display screen corresponds to the partial form factor of the mobile device.

Although the specific display states 106 are intended to provide an optimum user experience in a respective device form factor 108, each of the display states 106 are implemented to provide a reasonable user experience for all of the use cases. For example, streaming video content is best viewed in the extended display state of the rollable display screen 104 in the expanded form factor of the mobile device 102. However, the streaming video content can also be viewed in the retracted display state of the display screen (e.g., corresponding to the compact form factor of the device), and can be viewed in the sensor display state of the display screen (e.g., corresponding to the partial form factor of the device). Accordingly, when the mobile device 102 is running on a low battery, the configuration manager 116 can initiate to configure the rollable display screen 104 in a display state 106 that is adequate for all use cases with respect to battery power consumption.

In an example, the retracted display state of the rollable display screen 104 corresponding to the compact form factor of the mobile device 102 can be utilized for displaying and viewing content with minimum battery power consumption. The configuration manager 116 can limit the screen size to the retracted display state and limits use of battery power to move the rollable display screen. Similarly, the sensor display state of the rollable display screen 104 corresponding to the partial form factor of the mobile device 102 (e.g., also referred to as the “peek” form factor) can be utilized for displaying and viewing content on the display screen. The front-facing viewable size of the rollable display screen 104 in the sensor display state conserves battery power while also providing that functionality of the device sensors, such as the front-facing camera, environment sensors, and the phone earpiece speaker, is available for use without having to power the slidable display mount 114 and reconfigure the rollable display screen.

In various implementations, the configuration manager 116 determines or detects the low battery power 124 of the device battery 122, and as described above, maintains the rollable display screen 104 in the current display state and form factor of the device, such as by limiting the powered operation of the slidable display mount 114 that translates the display screen into the different display states 106. As an alternative to determining the low battery power 124 and maintaining the current display state, the configuration manager 116 can determine the low battery power 124 and first initiate to configure the rollable display screen 104 in a predefined low power display state, and then limit the powered operation of the slidable display mount 114 after the rollable display screen is configured in the predefined low power display state. Accordingly, low battery power 124 of the device battery 122 is determined or detected, some battery power is used to reconfigure the rollable display screen 104 in a display state 106 (e.g., in a predefined low power display state in this example), and then remaining battery power is conserved by limiting display screen translation.

In an implementation, the predefined low power display state may be a user preferred display state of the rollable display screen, such as if the user of the device prefers to configure the rollable display screen 104 in the sensor display state (corresponding to the partial form factor of the device) rather than in the retracted display state (corresponding to the compact form factor of the device) when operating in the low battery power mode. In similar implementations, the configuration manager 116 can determine that a current display state of the rollable display screen 104 utilizes less battery power than moving the slidable display mount 114 to reconfigure the display screen in a different display state, and maintain the rollable display screen in the current display state. Alternatively, the configuration manager 116 can determine that a current display state of the rollable display screen 104 utilizes more battery power than reconfiguring the rollable display screen 104 in a different display state, and initiate to reconfigure the display screen corresponding to either the compact form factor or the partial form factor of the mobile device.

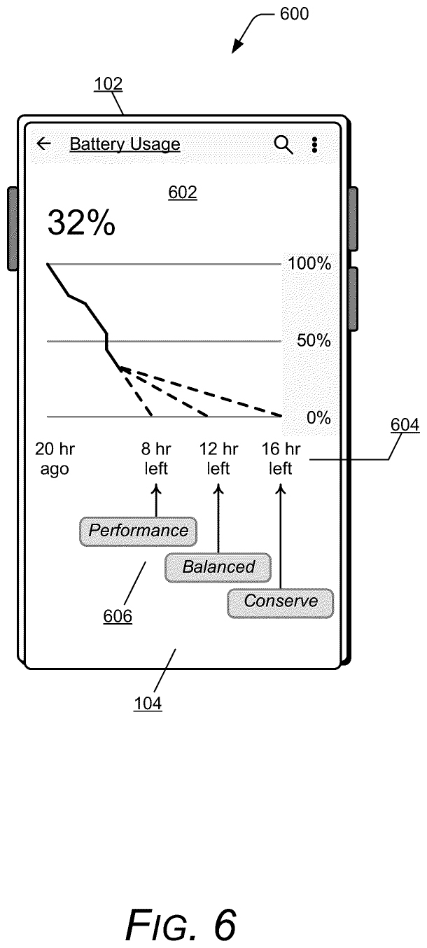

In another implementation, the configuration manager 116 receives a configuration input of a display state 106 of the rollable display screen 104, initiates to configure the rollable display screen according to the configuration input, and then maintains the rollable display screen in the display state corresponding to the configuration input. In an example, the configuration input is a user-selected display state of the rollable display screen corresponding to any of the device form factors 108, such as the compact form factor, the expanded form factor, or the partial form factor of the device. In this example, the user of the device can select the display state of the rollable display screen via a user interface selectable mode control displayed on a user interface, or via another type of selectable device control, such as by sensor input or switch input. As further shown and described with reference to FIG. 6, a user interface displays hours of remaining device operation based on the battery power 124 of the device battery 122, and the selectable battery modes 126 that correspond to the device form factors 108.

In implementations, the battery modes 126 include a conserve mode, a balanced mode, and a performance mode. The device form factors 108 may include the compact form factor or the partial form factor corresponding to the conserve mode of battery utilization, and may include the expanded form factor or the partial form factor corresponding to the performance mode of battery utilization. In the performance battery mode, the configuration manager 116 continues to automatically configure the rollable display screen 104 according to the predefined auto-expand and retract use cases, such as according to the content being displayed on the display screen. In the balanced battery mode, the configuration manager 116 is implemented to automatically expand and retract the rollable display screen 104 in a balanced manner, such as when taking a phone call or for messaging applications, but the fully extended display state may be limited, or the rollable display screen 104 may be partially extended. This may also be controlled or predefined by user preferences and/or based on usage patterns, such as how the user typically uses the device and in which battery modes, display states 106, and/or device form factors 108. In the conserve battery mode, the configuration manager 116 limits powered operation to reconfigure the rollable display screen 104, and maintains the display screen in the current display state.

FIG. 2 further illustrates example views 200 of the mobile device in aspects of rollable screen device power management, as described herein. In these example views 200, the mobile device 102 is shown in a front view 202 in the partial form factor (e.g., also referred to as the “peek” form factor), with the rollable display screen 104 configured in the sensor display state. In this configuration, the rollable display screen 104 translates down (e.g., in an opposite direction of the extended display state). This sensor display state provides for an unobstructed sensory view of various device sensors 204 and/or components that are otherwise hidden behind the rollable display screen 104 in both the compact form factor (retracted display state) and expanded form factor (extended display state). For example, the device sensors 204, such as a front-facing camera, environment sensors (e.g., for motion, sound, lighting, etc.), a proximity sensor, and/or phone earpiece speaker can all be integrated in the mobile device 102 under the rollable display screen 104, and the slidable display mount 114 translates the display screen over or above the sensors. These under-the-display screen sensors are then exposed or visible for use in the sensor display state of the rollable display screen 104 that corresponds to the partial form factor of the mobile device 102. In these example views 200, the mobile device 102 is also shown in a back view 206 in the partial form factor of the device, with the rollable display screen 104 configured in the sensor display state. The rollable display screen 104 is translated by the slidable display mount 114 around the device housing, and forms the rear-facing portion of the display screen.

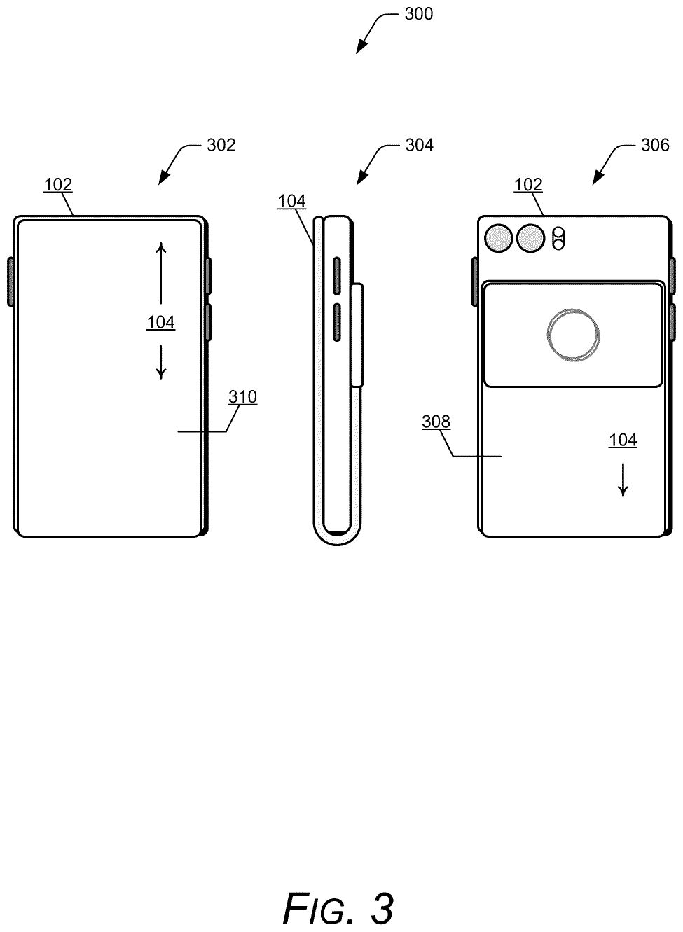

FIG. 3 further illustrates example views 300 of the mobile device in aspects of rollable screen device power management, as described herein. In these example views 300, the mobile device 102 is shown in a front view 302, a side view 304, and a back view 306 in the compact form factor, with the rollable display screen 104 configured in the retracted display state. In this configuration, a portion of the rollable display screen 104 rotates around the housing of the mobile device 102, forming a rear-facing portion 308 of the display screen (e.g., relative to the front-facing portion 310 of the display screen). In implementations, both the front-facing portion 310 and the rear-facing portion 308 of the rollable display screen 104 can be used to display content, such as related content or content associated with different applications.

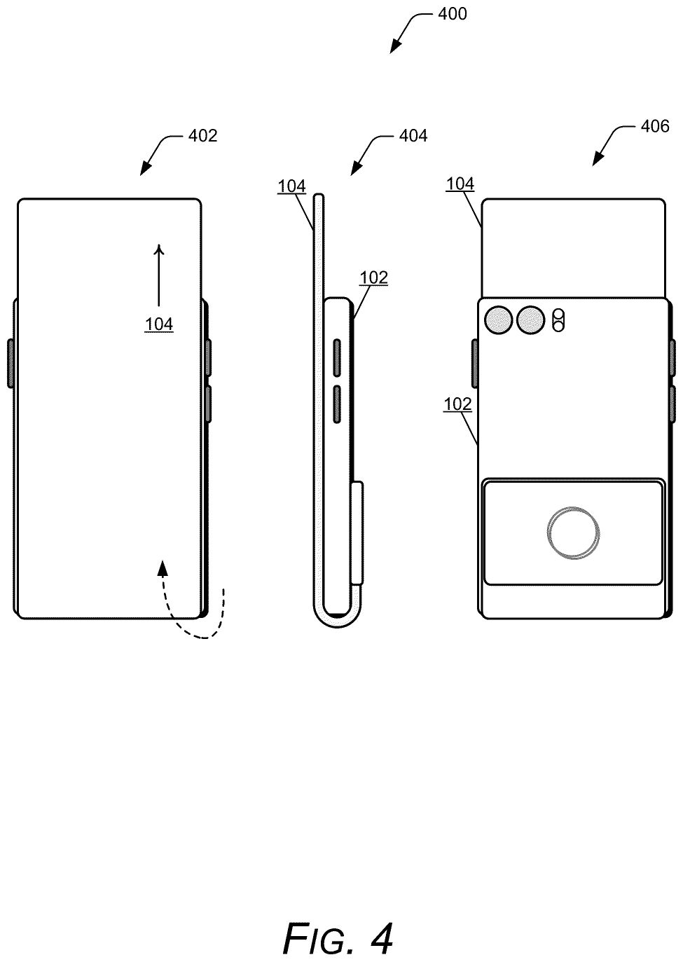

FIG. 4 further illustrates example views 400 of the mobile device in aspects of rollable screen device power management, as described herein. In these example views 400, the mobile device 102 is shown in a front view 402, a side view 404, and a back view 406 in the expanded form factor, with the rollable display screen 104 configured in the extended display state. In this configuration, the rear-facing portion of the rollable display screen 104 rotates around the device housing and becomes part of the front-facing portion of the display screen. Notably, the viewable display area of the rollable display screen 104 varies as the display screen is translated from the sensor display state to the retracted display state to the extended display state, and back.

As illustrated in the figures, the slidable display mount 114 translates the rollable display screen 104 around the device housing to change the overall length of the flexible display as viewed from the front of the mobile device 102 (e.g., as shown in the front view 402). The slidable display mount 114 also translates the rollable display screen 104 in an opposite direction around the device housing to the retracted display state in the compact form factor of the device, and more of the rollable display screen 104 is viewable as the rear-facing portion of the display. Content, such as any type of graphics and images, can be displayed on any section of the rollable display screen 104, including on the front-facing portion, on the rear-facing portion, and/or on the curved end portion of the display screen.

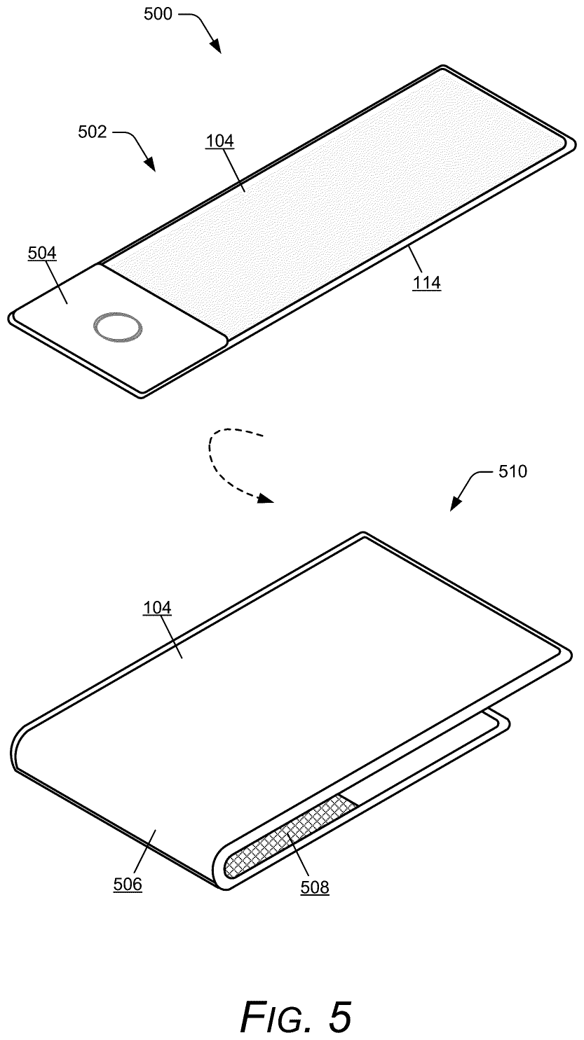

FIG. 5 illustrates example views 500 of the rollable display screen and the slidable display mount of the mobile device in aspects of rollable screen device power management, as described herein. In these example views 500, the rollable display screen 104 integrated with the slidable display mount 114 is shown configured at 502, along with a backplate 504. A display roller mechanism can be implemented to facilitate the flexible display and mounting assembly (e.g., the rollable display screen 104 and the slidable display mount 114) wrapping around the device housing. The display roller mechanism includes a rotor positioned within the curvilinear section 506 of the flexible display and mounting assembly to facilitate translation of the rollable display screen 104 in the various display states. In one or more implementations, the slidable display mount 114 includes a substrate that includes a flexible portion 508, which allows the flexible display and mounting assembly to wrap and deform around the device housing. As shown at 510, the rollable display screen 104 and the slidable display mount 114 are wrapped around to form the curvilinear section 506 of the flexible display, along with two linear sections of the display as the front-facing portion and the rear-facing portion of the rollable display screen. As shown in the example views 500, a cross section of the rollable display screen 104 and the slidable display mount 114 forms a J-shape or U-shape with the curvilinear section 506 of the display.

FIG. 6 further illustrates an example 600 of a user interface in aspects of rollable screen device power management, as described herein. In this example 600, the user interface 602 is an example of a device application 118 that has an associated application user interface 120, which is generated and displayed for user interaction and/or viewing, such as on the rollable display screen 104 of the mobile device 102. For example, the user interface 602 is an application user interface of the configuration manager 116 (e.g., if the configuration manager is implemented at least partially as a device application), and/or a user interface of a battery power application. In one or more implementations, the user interface 602 displays indications 604 (e.g., as estimated hours of remaining device operation) of the battery power 124 of the device battery 122 remaining in the battery modes 126 corresponding to the device form factors 108 and sizes of display screen options. In this example 600, the user interface 602 includes user-selectable mode controls 606 via which a user of the mobile device 102 can select a battery mode to continue device use.

In implementations, the battery modes 126 include a conserve mode, a balanced mode, and a performance mode. The device form factors 108 may include the compact form factor or the partial form factor corresponding to the conserve mode of battery utilization, and may include the expanded form factor or the partial form factor corresponding to the performance mode of battery utilization. In the performance battery mode, the configuration manager 116 continues to automatically configure the rollable display screen 104 according to the predefined auto-expand and retract use cases, such as according to the content being displayed on the display screen. In the balanced battery mode, the configuration manager 116 is implemented to automatically expand and retract the rollable display screen 104 in a balanced manner, such as when taking a phone call or for messaging applications, but the fully extended display state may be limited, or the rollable display screen 104 may be partially extended. This may also be controlled or predefined by user preferences. In the conserve battery mode, the configuration manager 116 limits powered operation to reconfigure the rollable display screen 104, and maintains the display screen in the current display state. In other configuration implementations, the configuration manager 116 may be implemented to force a device form factor, such as the compact form factor, when the battery power of the device battery reaches or is reduced below an operable battery power threshold (e.g., approximately 10% battery power remaining).

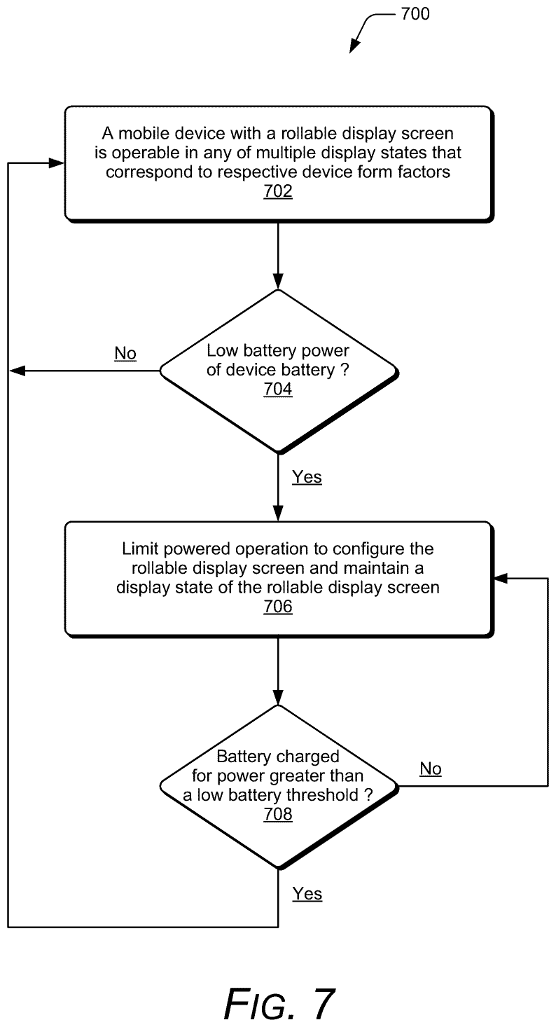

Example methods 700, 800, 900, 1000, 1100, and 1200 are described with reference to respective FIGS. 7-12 in accordance with one or more implementations for rollable screen device power management, as described herein. Generally, any services, components, modules, managers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 7 illustrates example method(s) 700 for rollable screen device power management. The order in which the method is described is not intended to be construed as a limitation, and any number or combination of the described method operations can be performed in any order to perform a method, or an alternate method.

At 702, a mobile device with a rollable display screen is operable in any of multiple display states that correspond to respective device form factors. For example, the mobile device 102 is implemented with the rollable display screen 104, which is operable in any of the multiple display states 106 that correspond to the respective device form factors 108. In one or more implementations, the extended display state of the rollable display screen 104 corresponds to the expanded form factor of the mobile device 102; the retracted display state of the rollable display screen corresponds to the compact form factor of the mobile device; and the sensor display state of the rollable display screen corresponds to the partial form factor of the mobile device.

At 704, a determination is made as to low battery power of the device battery. For example, the configuration manager 116 determines whether the battery power 124 remaining for the device battery 122 is low battery power (e.g., such as based on a comparison to a low battery threshold). If the battery power of the device battery is not low (i.e., “No” from 704), then at 702, the mobile device 102 with the rollable display screen 104 continues to be operable in any of the multiple display states 106 that correspond to the respective device form factors 108.

If the battery power of the device battery is low (i.e., “Yes” from 704), then at 706, powered operation to configure (or reconfigure) the rollable display screen is limited, and the display state of the rollable display screen is maintained. For example, the configuration manager 116 limits powered operation of the slidable display mount 114 to configure the rollable display screen 104, and maintains the rollable display screen 104 in a current display state based on the low battery power of the device battery 122.

At 708, a determination is made as to whether the device battery is charged for power greater than a low battery threshold. For example, the configuration manager 116 determines whether the device battery 122 has been charged (or is charging) to a power capacity greater than (and/or at least equal to) the low battery threshold. If the battery power of the device battery 122 is not greater than (and/or at least equal to) the low battery threshold (i.e., “No” from 708), then at 706, the configuration manager 116 continues to limit the powered operation to configure (or reconfigure) the rollable display screen 104, and the display state of the rollable display screen is maintained. Alternatively, if the battery power of the device battery 122 is greater than (and/or at least equal to) the low battery threshold (i.e., “Yes” from 708), then at 702, the mobile device 102 with the rollable display screen 104 is again operable in any of the multiple display states 106 that correspond to the respective device form factors 108.

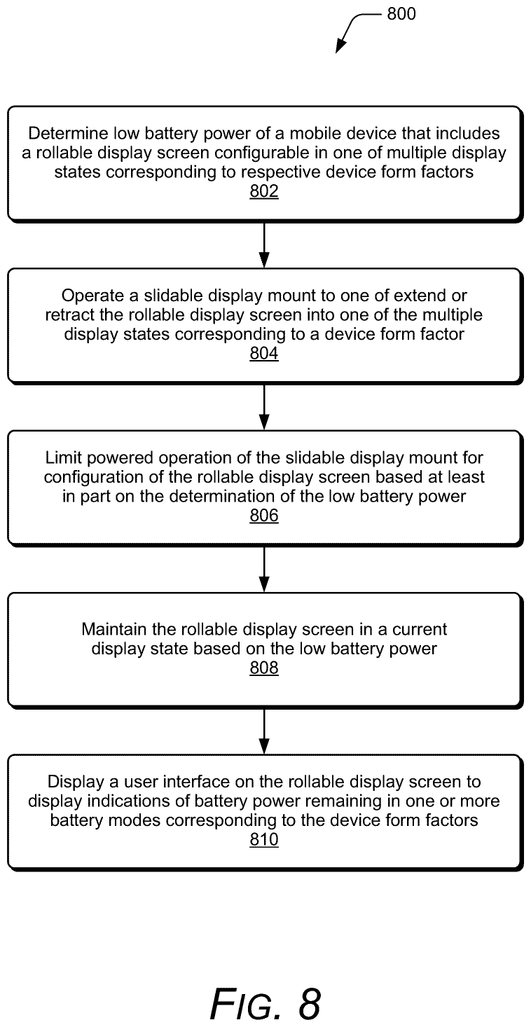

FIG. 8 illustrates example method(s) 800 for rollable screen device power management. The order in which the method is described is not intended to be construed as a limitation, and any number or combination of the described method operations can be performed in any order to perform a method, or an alternate method.

At 802, low battery power is determined for a mobile device that includes a rollable display screen configurable in one of multiple display states corresponding to respective device form factors. For example, the configuration manager 116 determines the battery power 124 remaining for the device battery 122 (e.g., a low battery power). The mobile device 102 includes the rollable display screen 104 configurable in one of the multiple display states 106 corresponding to the respective device form factors 108, which include the compact form factor, the expanded form factor, and the partial form factor.

At 804, a slidable display mount is operated to one of extend or retract the rollable display screen into one of the multiple display states corresponding to a device form factor. For example, the configuration manager 116 initiates to operate the slidable display mount 114 to extend or retract the rollable display screen 104 into one of the multiple display states 106 corresponding to a device form factor 108.

At 806, powered operation of the slidable display mount is limited for configuration of the rollable display screen based at least in part on the determination of the low battery power. For example, the configuration manager 116 limits powered operation of the slidable display mount 114 based on the low battery power of the device battery 122.

At 808, the rollable display screen is maintained in a current display state based on the low battery power. For example, the configuration manager 116 maintains the rollable display screen 104 in a current display state based on the low battery power of the device battery 122.

At 810, a user interface is displayed on the rollable display screen to display indications of battery power remaining in one or more battery modes corresponding to the device form factors. For example, the user interface 602 is displayed on the rollable display screen 104 to display the indications 604 of the battery power 124 remaining in the one or more battery modes 126 corresponding to the device form factors 108. The one or more battery modes 126 include a conserve mode, a balanced mode, and a performance mode. The device form factors may include the compact form factor or the partial form factor corresponding to the conserve mode, and may include the expanded form factor or the partial form factor corresponding to the performance mode.

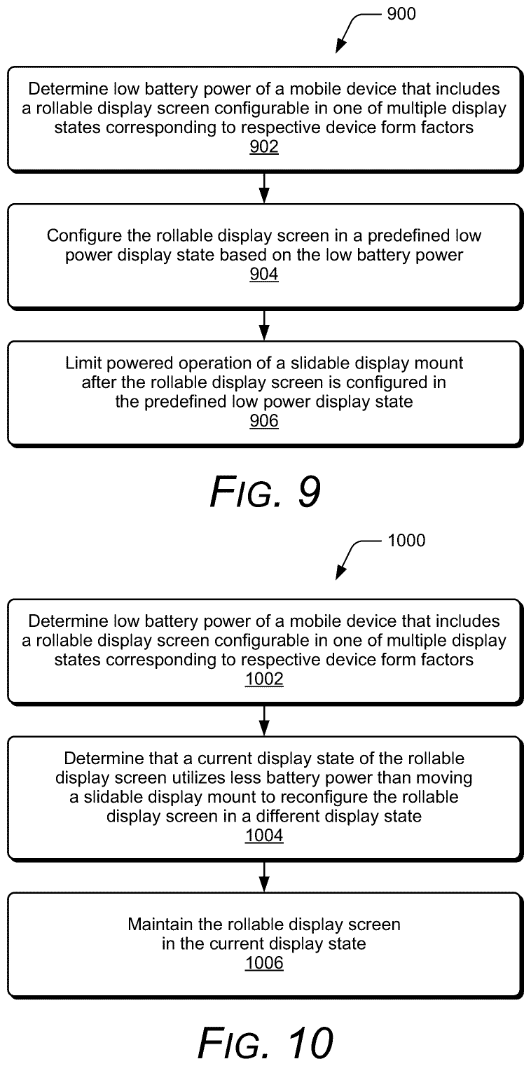

FIG. 9 illustrates example method(s) 900 for rollable screen device power management. The order in which the method is described is not intended to be construed as a limitation, and any number or combination of the described method operations can be performed in any order to perform a method, or an alternate method.

At 902, low battery power is determined for a mobile device that includes a rollable display screen configurable in one of multiple display states corresponding to respective device form factors. For example, the configuration manager 116 determines the battery power 124 remaining for the device battery 122 (e.g., a low battery power). The mobile device 102 includes the rollable display screen 104 configurable in one of the multiple display states 106 corresponding to the respective device form factors 108, which include the compact form factor, the expanded form factor, and the partial form factor.

At 904, the rollable display screen is configured in a predefined low power display state based on the low battery power. For example, the configuration manager 116 configures the rollable display screen 104 in a predefined low power display state based on the low battery power 124 of the device battery 122. In an implementation, the predefined low power display state is a user preferred display state of the rollable display screen.

At 906, powered operation of a slidable display mount is limited after the rollable display screen is configured in the predefined low power display state. For example, the configuration manager 116 limits powered operation of the slidable display mount 114 after the rollable display screen 104 is configured in the predefined low power display state.

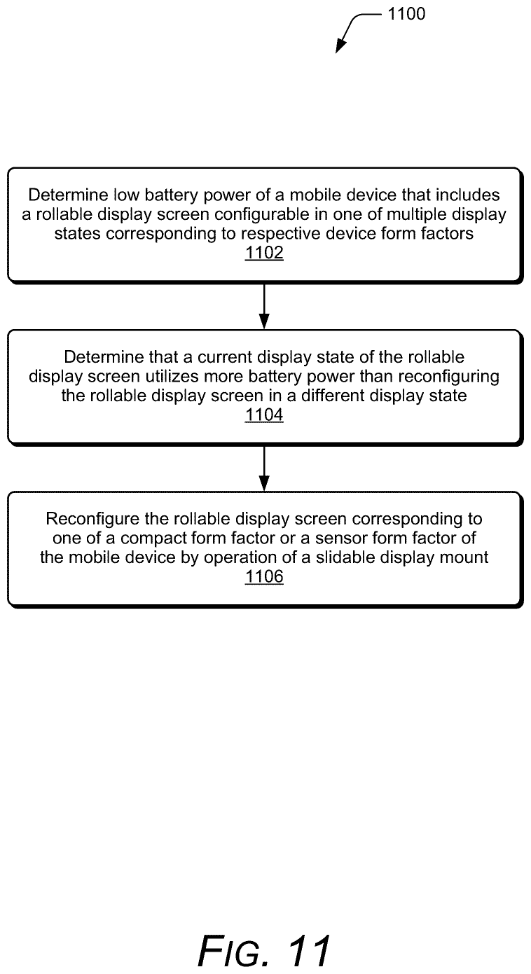

FIG. 10 illustrates example method(s) 1000 for rollable screen device power management. The order in which the method is described is not intended to be construed as a limitation, and any number or combination of the described method operations can be performed in any order to perform a method, or an alternate method.

At 1002, low battery power is determined for a mobile device that includes a rollable display screen configurable in one of multiple display states corresponding to respective device form factors. For example, the configuration manager 116 determines the battery power 124 remaining for the device battery 122 (e.g., a low battery power). The mobile device 102 includes the rollable display screen 104 configurable in one of the multiple display states 106 corresponding to the respective device form factors 108, which include the compact form factor, the expanded form factor, and the partial form factor.

At 1004, a determination is made that a current display state of the rollable display screen utilizes less battery power than moving a slidable display mount to reconfigure the rollable display screen in a different display state. For example, the configuration manager 116 determines that a current display state 106 of the rollable display screen 104 utilizes less battery power of the device battery 122 than moving the slidable display mount 114 to reconfigure the rollable display screen in a different display state.

At 1006, the rollable display screen is maintained in the current display state. For example, the configuration manager 116 maintains the rollable display screen 104 in the current display state based on the determination that the current display state of the rollable display screen utilizes less battery power than moving the slidable display mount 114 to reconfigure the rollable display screen in a different display state.

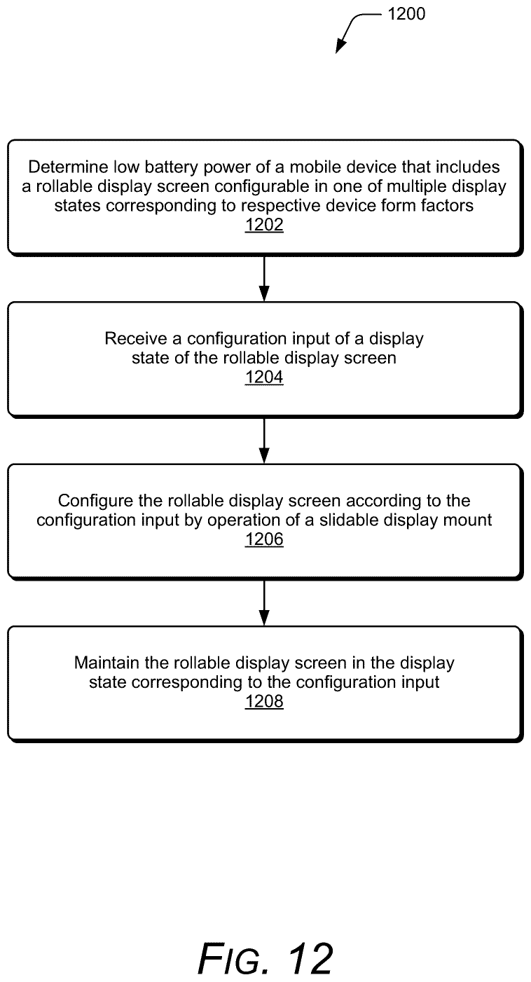

FIG. 11 illustrates example method(s) 1100 for rollable screen device power management. The order in which the method is described is not intended to be construed as a limitation, and any number or combination of the described method operations can be performed in any order to perform a method, or an alternate method.

At 1102, low battery power is determined for a mobile device that includes a rollable display screen configurable in one of multiple display states corresponding to respective device form factors. For example, the configuration manager 116 determines the battery power 124 remaining for the device battery 122 (e.g., a low battery power). The mobile device 102 includes the rollable display screen 104 configurable in one of the multiple display states 106 corresponding to the respective device form factors 108, which include the compact form factor, the expanded form factor, and the partial form factor.

At 1104, a determination is made that a current display state of the rollable display screen utilizes more battery power than reconfiguring the rollable display screen in a different display state. For example, the configuration manager 116 determines that a current display state 106 of the rollable display screen 104 utilizes more battery power of the device battery 122 than reconfiguring the rollable display screen in a different display state.

At 1106, the rollable display screen is reconfigured corresponding to one of a compact form factor or a sensor form factor of the mobile device by operation of a slidable display mount. For example, the configuration manager 116 the initiates to reconfigure the rollable display screen 104 corresponding to the compact form factor or the sensor form factor of the mobile device 102 by operation of the slidable display mount 114 that translates the flexible display.

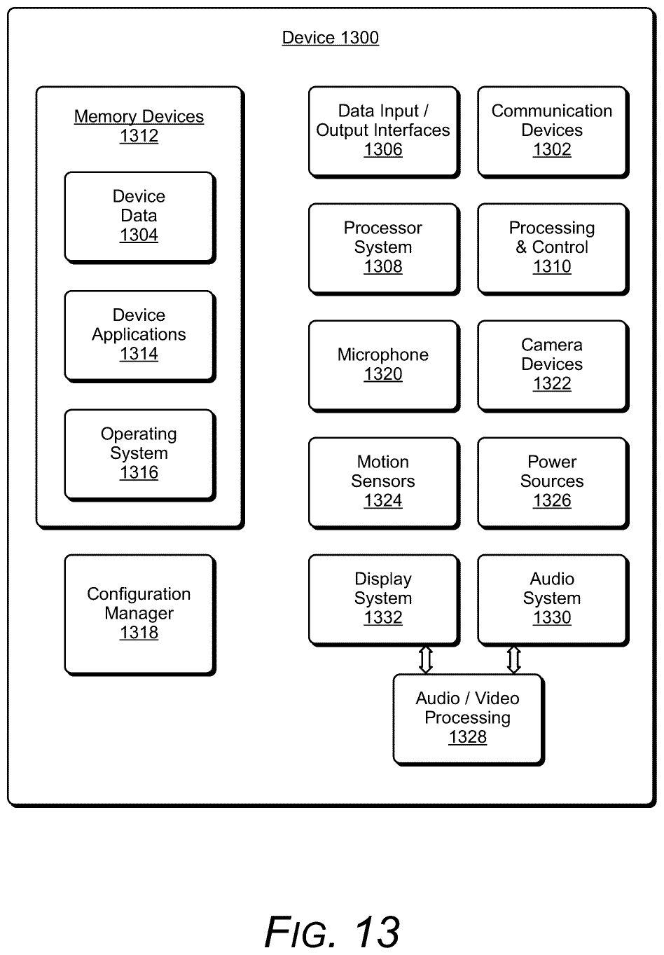

FIG. 12 illustrates example method(s) 1200 for rollable screen device power management. The order in which the method is described is not intended to be construed as a limitation, and any number or combination of the described method operations can be performed in any order to perform a method, or an alternate method.

At 1202, low battery power is determined for a mobile device that includes a rollable display screen configurable in one of multiple display states corresponding to respective device form factors. For example, the configuration manager 116 determines the battery power 124 remaining for the device battery 122 (e.g., a low battery power). The mobile device 102 includes the rollable display screen 104 configurable in one of the multiple display states 106 corresponding to the respective device form factors 108, which include the compact form factor, the expanded form factor, and the partial form factor.

At 1204, a configuration input of a display state of the rollable display screen is received. For example, the configuration manager 116 receives a configuration input for a selected display state 106 of the rollable display screen 104. In an implementation, the configuration input is a user-selected display state of the rollable display screen 104 corresponding to a device form factor 108 as one of a compact form factor, an expanded form factor, or a partial form factor.

At 1206, the rollable display screen is configured according to the configuration input by operation of a slidable display mount. For example, the configuration manager 116 initiates to configure the rollable display screen 104 according to the configuration input by operation of the slidable display mount 114 that translates the flexible display into a display state 106 corresponding to a respective device form factor 108.

At 1208, the rollable display screen is maintained in the display state corresponding to the configuration input. For example, the configuration manager 116 maintains the rollable display screen 104 in the display state 106 that corresponds to the configuration input.

FIG. 13 illustrates various components of an example device 1300, which can implement aspects of the techniques and features for rollable screen device power management, as described herein. The example device 1300 can be implemented as any of the devices described with reference to the previous FIGS. 1-12, such as any type of a wireless device, mobile device, mobile phone, flip phone, client device, companion device, paired device, display device, tablet, computing, communication, entertainment, gaming, media playback, and/or any other type of computing and/or electronic device. For example, the mobile device 102 described with reference to FIGS. 1-12 may be implemented as the example device 1300.

The example device 1300 can include various, different communication devices 1302 that enable wired and/or wireless communication of device data 1304 with other devices. The device data 1304 can include any of the various devices data and content that is generated, processed, determined, received, stored, and/or communicated from one computing device to another. Generally, the device data 1304 can include any form of audio, video, image, graphics, and/or electronic data that is generated by applications executing on a device. The communication devices 1302 can also include transceivers for cellular phone communication and/or for any type of network data communication.

The example device 1300 can also include various, different types of data input/output (I/O) interfaces 1306, such as data network interfaces that provide connection and/or communication links between the devices, data networks, and other devices. The I/O interfaces 1306 can be used to couple the device to any type of components, peripherals, and/or accessory devices, such as a computer input device that may be integrated with the example device 1300. The I/O interfaces 1306 may also include data input ports via which any type of data, information, media content, communications, messages, and/or inputs can be received, such as user inputs to the device, as well as any type of audio, video, image, graphics, and/or electronic data received from any content and/or data source.

The example device 1300 includes a processor system 1308 of one or more processors (e.g., any of microprocessors, controllers, and the like) and/or a processor and memory system implemented as a system-on-chip (SoC) that processes computer-executable instructions. The processor system 1308 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that may be implemented in connection with processing and control circuits, which are generally identified at 1310. The example device 1300 may also include any type of a system bus or other data and command transfer system that couples the various components within the device. A system bus can include any one or combination of different bus structures and architectures, as well as control and data lines.

The example device 1300 also includes memory and/or memory devices 1312 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 1312 include volatile memory and non-volatile memory, fixed and removable media devices, and any suitable memory device or electronic data storage that maintains data for computing device access. The memory devices 1312 can include various implementations of random-access memory (RAM), read-only memory (ROM), flash memory, and other types of storage media in various memory device configurations. The example device 1300 may also include a mass storage media device.

The memory devices 1312 (e.g., as computer-readable storage memory) provide data storage mechanisms, such as to store the device data 1304, other types of information and/or electronic data, and various device applications 1314 (e.g., software applications and/or modules). For example, an operating system 1316 can be maintained as software instructions with a memory device 1312 and executed by the processor system 1308 as a software application. The device applications 1314 may also include a device manager, such as any form of a control application, software application, signal-processing and control module, code that is specific to a particular device, a hardware abstraction layer for a particular device, and so on.

In this example, the device 1300 includes a configuration manager 1318 that implements various aspects of the described features and techniques described herein. The configuration manager 1318 can be implemented with hardware components and/or in software as one of the device applications 1314, such as when the example device 1300 is implemented as the mobile device 102 described with reference to FIGS. 1-12. An example of the configuration manager 1318 is the configuration manager 116 implemented in the mobile device 102, such as a software application and/or as hardware components in the wireless device. In implementations, the configuration manager 1318 may include independent processing, memory, and logic components as a computing and/or electronic device integrated with the example device 1300.

The example device 1300 can also include a microphone 1320 and/or camera devices 1322, as well as motion sensors 1324, such as may be implemented as components of an inertial measurement unit (IMU). The motion sensors 1324 can be implemented with various sensors, such as a gyroscope, an accelerometer, and/or other types of motion sensors to sense motion of the device. The motion sensors 1324 can generate sensor data vectors having three-dimensional parameters (e.g., rotational vectors in x, y, and z-axis coordinates) indicating location, position, acceleration, rotational speed, and/or orientation of the device. The example device 1300 can also include one or more power sources 1326, such as when the device is implemented as a wireless device and/or mobile device. The power sources may include a charging and/or power system, and can be implemented as a flexible strip battery, a rechargeable battery, a charged super-capacitor, and/or any other type of active or passive power source.

The example device 1300 can also include an audio and/or video processing system 1328 that generates audio data for an audio system 1330 and/or generates display data for a display system 1332. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 1300. Alternatively, the audio system and/or the display system are external, peripheral components to the example device.

Although implementations of rollable screen device power management have been described in language specific to features and/or methods, the appended claims are not necessarily limited to the specific features or methods described. Rather, the specific features and methods are disclosed as example implementations of rollable screen device power management, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A mobile device, comprising a rollable display screen configurable in one of multiple display states corresponding to respective device form factors; a slidable display mount operable to one of extend or retract the rollable display screen into one of the multiple display states corresponding to a device form factor; and a configuration manager implemented at least partially in computer hardware and configured to limit powered operation of the slidable display mount for configuration of the rollable display screen based at least in part on a determination of low battery power.

Alternatively or in addition to the above described mobile device, any one or combination of: the respective device form factors include a compact form factor, an expanded form factor, and a partial form factor. Based on the determination of the low battery power, the configuration manager is configured to maintain the rollable display screen in a current display state. Based on the determination of the low battery power, the configuration manager is configured to initiate to configure the rollable display screen in a predefined low power display state; and limit the powered operation of the slidable display mount after the rollable display screen is configured in the predefined low power display state. The predefined low power display state is a user preferred display state of the rollable display screen. The configuration manager is configured to determine that a current display state of the rollable display screen utilizes less battery power than moving the slidable display mount to reconfigure the rollable display screen in a different display state; and maintain the rollable display screen in the current display state. The configuration manager is configured to determine that a current display state of the rollable display screen utilizes more battery power than reconfiguring the rollable display screen in a different display state; and initiate to reconfigure the rollable display screen corresponding to a compact form factor of the mobile device. The configuration manager is configured to receive a configuration input of a display state of the rollable display screen; initiate to configure the rollable display screen according to the configuration input; and maintain the rollable display screen in the display state corresponding to the configuration input. The configuration input is a user-selected display state of the rollable display screen corresponding to the device form factor as one of a compact form factor, an expanded form factor, or a partial form factor. The configuration manager is configured to initiate to configure the rollable display screen in a user-selected display state; and limit the powered operation of the slidable display mount after the rollable display screen is configured in the user-selected display state. The mobile device further comprising a user interface displayable on the rollable display screen to display indications of battery power remaining in one or more battery modes corresponding to the device form factors, the one or more battery modes including a conserve mode, a balanced mode, and a performance mode.

A method, comprising determining low battery power of a mobile device that includes a rollable display screen configurable in one of multiple display states corresponding to respective device form factors; operating a slidable display mount to one of extend or retract the rollable display screen into one of the multiple display states corresponding to a device form factor; and limiting powered operation of the slidable display mount for configuration of the rollable display screen based at least in part on the determination of the low battery power.

Alternatively or in addition to the above described method, any one or combination of: the method further comprising maintaining the rollable display screen in a current display state based on the low battery power. The method further comprising configuring the rollable display screen in a predefined low power display state based on the low battery power; and limiting the powered operation of the slidable display mount after the rollable display screen is configured in the predefined low power display state. The method further comprising determining that a current display state of the rollable display screen utilizes less battery power than moving the slidable display mount to reconfigure the rollable display screen in a different display state; and maintaining the rollable display screen in the current display state. The method further comprising determining that a current display state of the rollable display screen utilizes more battery power than reconfiguring the rollable display screen in a different display state; and reconfiguring the rollable display screen corresponding to one of a compact form factor or a sensor form factor of the mobile device. The method further comprising receiving a configuration input of a display state of the rollable display screen; configuring the rollable display screen according to the configuration input; and maintaining the rollable display screen in the display state corresponding to the configuration input. The configuration input is a user-selected display state of the rollable display screen corresponding to the device form factor as one of a compact form factor, an expanded form factor, or a partial form factor.

A mobile device, comprising a rollable display screen configurable in one of multiple display states corresponding to respective device form factors; a slidable display mount operable to one of extend or retract the rollable display screen into one of the multiple display states corresponding to a device form factor; and a user interface displayable on the rollable display screen to display indications of battery power remaining in one or more battery modes corresponding to the device form factors, the one or more battery modes including a conserve mode, a balanced mode, and a performance mode.

Alternatively or in addition to the above described mobile device, any one or combination of: the respective device form factors include a compact form factor corresponding to the conserve mode, and an expanded form factor corresponding to the performance mode.

1. A mobile device, comprising:
a rollable display screen configurable in one of multiple display states corresponding to respective device form factors;
a slidable display mount operable to one of extend or retract the rollable display screen into one of the multiple display states corresponding to a device form factor; and
a configuration manager implemented at least partially in computer hardware and configured to limit powered operation of the slidable display mount for configuration of the rollable display screen based at least in part on a determination of low battery power.

2. The mobile device of claim 1, wherein the respective device form factors include a compact form factor, an expanded form factor, and a partial form factor.

3. The mobile device of claim 1, wherein, based on the determination of the low battery power, the configuration manager is configured to maintain the rollable display screen in a current display state.

4. The mobile device of claim 1, wherein, based on the determination of the low battery power, the configuration manager is configured to:
initiate to configure the rollable display screen in a predefined low power display state; and
limit the powered operation of the slidable display mount after the rollable display screen is configured in the predefined low power display state.

5. The mobile device of claim 4, wherein the predefined low power display state is a user preferred display state of the rollable display screen.

6. The mobile device of claim 1, wherein the configuration manager is configured to:
determine that a current display state of the rollable display screen utilizes less battery power than moving the slidable display mount to reconfigure the rollable display screen in a different display state; and
maintain the rollable display screen in the current display state.

7. The mobile device of claim 1, wherein the configuration manager is configured to:
determine that a current display state of the rollable display screen utilizes more battery power than reconfiguring the rollable display screen in a different display state; and
initiate to reconfigure the rollable display screen corresponding to a compact form factor of the mobile device.

8. The mobile device of claim 1, wherein the configuration manager is configured to:
receive a configuration input of a display state of the rollable display screen;
initiate to configure the rollable display screen according to the configuration input; and
maintain the rollable display screen in the display state corresponding to the configuration input.

9. The mobile device of claim 8, wherein the configuration input is a user-selected display state of the rollable display screen corresponding to the device form factor as one of a compact form factor, an expanded form factor, or a partial form factor.

10. The mobile device of claim 1, wherein the configuration manager is configured to:
initiate to configure the rollable display screen in a user-selected display state; and
limit the powered operation of the slidable display mount after the rollable display screen is configured in the user-selected display state.

11. The mobile device of claim 1, further comprising:
a user interface displayable on the rollable display screen to display indications of battery power remaining in one or more battery modes corresponding to the device form factors, the one or more battery modes including a conserve mode, a balanced mode, and a performance mode.

12. A method, comprising:
determining low battery power of a mobile device that includes a rollable display screen configurable in one of multiple display states corresponding to respective device form factors;
operating a slidable display mount to one of extend or retract the rollable display screen into one of the multiple display states corresponding to a device form factor; and
limiting powered operation of the slidable display mount for configuration of the rollable display screen based at least in part on the determination of the low battery power.

13. The method of claim 12, further comprising maintaining the rollable display screen in a current display state based on the low battery power.

14. The method of claim 12, further comprising:
configuring the rollable display screen in a predefined low power display state based on the low battery power; and
limiting the powered operation of the slidable display mount after the rollable display screen is configured in the predefined low power display state.

15. The method of claim 12, further comprising:
determining that a current display state of the rollable display screen utilizes less battery power than moving the slidable display mount to reconfigure the rollable display screen in a different display state; and
maintaining the rollable display screen in the current display state.

16. The method of claim 12, further comprising:
determining that a current display state of the rollable display screen utilizes more battery power than reconfiguring the rollable display screen in a different display state; and
reconfiguring the rollable display screen corresponding to one of a compact form factor or a sensor form factor of the mobile device.

17. The method of claim 12, further comprising:
receiving a configuration input of a display state of the rollable display screen;
configuring the rollable display screen according to the configuration input; and
maintaining the rollable display screen in the display state corresponding to the configuration input.

18. The method of claim 17, wherein the configuration input is a user-selected display state of the rollable display screen corresponding to the device form factor as one of a compact form factor, an expanded form factor, or a partial form factor.

19. A mobile device, comprising:
a rollable display screen configurable in one of multiple display states corresponding to respective device form factors;
a slidable display mount operable to one of extend or retract the rollable display screen into one of the multiple display states corresponding to a device form factor; and
a user interface displayable on the rollable display screen to display indications of battery power remaining in one or more battery modes corresponding to the device form factors, the one or more battery modes including a conserve mode, a balanced mode, and a performance mode.

20. The mobile device of claim 19, wherein the respective device form factors include a compact form factor corresponding to the conserve mode, and an expanded form factor corresponding to the performance mode.
